(19) United States
(12) Patent Application Publication
(10) Pub. No.: US 2026/0236028 A1
(43) Pub. Date: Aug. 13, 2026

(54) ELECTRONIC APPARATUS AND CONTROL METHOD THEREOF

(71) Applicant: SAMSUNG ELECTRONICS CO., LTD., Suwon-si (KR)

(72) Inventors: Soonbeom KWON, Suwon-si (KR); Jaeha LEE, Suwon-si (KR); Yunsung JUNG, Suwon-si (KR); Gohwoon JEONG, Suwon-si (KR); Jinoh KIM, Suwon-Si (KR)

(21) Appl. No.: 19/639,790

(22) Filed: Apr. 6, 2026

Related U.S. Application Data
(63) Continuation of application No. PCT/KR2026/001844, filed on Jan. 30, 2026.

(30) Foreign Application Priority Data
Feb. 4, 2025 (KR) 10-2025-0014080

(51) Int. Cl. G05D 1/43; G05D 1/246

(52) U.S. Cl. CPC G05D 1/43; G05D 1/246

(57) ABSTRACT

An electronic apparatus includes: a distance sensor configured to measure a distance from a wall surface; a depth sensor; a travel device including a motor; a memory storing at least one instruction; and at least one processor configured to execute the at least one instruction, wherein the at least one processor is configured to cause the apparatus to: acquire first map data based on distance information from the wall surface acquired using the distance sensor, control the travel device to move to a position corresponding to a scan pose for a reference point corresponding to scan data collection based on the first map data, and acquire second map data based on scan data acquired using the depth sensor at the position corresponding to the scan pose.

### CROSS-REFERENCE TO RELATED APPLICATIONS

This application is a continuation of International Application No. PCT/KR2026/001844 designating the United States, filed on Jan. 30, 2026, in the Korean Intellectual Property Receiving Office and claiming priority to Korean Patent Application No. 10-2025-0014080, filed on Feb. 4, 2025, in the Korean Intellectual Property Office, the disclosures of each of which are incorporated by reference herein in their entireties.

### BACKGROUND

### Field

The disclosure relates to an electronic apparatus for acquiring map data and a control method thereof.

### Description of Related Art

With the development of electronic technology, various types of electronic apparatuses are used in daily life. Such electronic apparatuses may include an electronic apparatus or the like for acquiring map data.

For example, the electronic apparatuses may include an electronic apparatus for acquiring map data based on distance information or an image acquired using a sensor while traveling within a space.

The map data refers to data representing structural information of a specific space or environment.

### SUMMARY

According to an example embodiment of the present disclosure, provided is an electronic apparatus including: a distance sensor configured to measure a distance from a wall surface; a depth sensor; a travel device comprising a motor; a memory storing at least one instruction; and at least one processor, comprising processing circuitry, individually and/or collectively, configured to execute the at least one instruction and to cause the electronic apparatus to: acquire first map data based on distance information from the wall surface acquired using the distance sensor, control the travel device to move to a position corresponding to a scan pose for a reference point corresponding to scan data collection based on the first map data, and acquire second map data based on scan data acquired using the depth sensor at the position corresponding to the scan pose.

At least one processor, individually and/or collectively, may be configured to cause the electronic apparatus to: acquire data corresponding to a first map including distance information from a plurality of wall surfaces based on the first map data, and acquire positions corresponding to a plurality of scan poses based on the distance information from the plurality of wall surfaces.

At least one processor, individually and/or collectively, may be configured to cause the electronic apparatus to: acquire, as the positions corresponding to the plurality of scan poses, a plurality of positions each corresponding to a specified value based on a distance from each of the plurality of wall surfaces exceeding the specified value.

At least one processor, individually and/or collectively, may be configured to cause the electronic apparatus to: acquire data corresponding to a first map including a plurality of grids based on the first map data, and acquire respective centers of the plurality of grids as positions corresponding to scan poses.

At least one processor, individually and/or collective, may be configured to cause the electronic apparatus to: acquire a scan rotation angle based on a field of view (FoV) of the depth sensor, and control the travel device to rotate based on the scan rotation angle to acquire the scan data using the depth sensor.

At least one processor, individually and/or collectively, may be configured to cause the electronic apparatus to: acquire spatial data from the second map data, and acquire data corresponding to a second map including the spatial data.

At least one processor, individually and/or collectively, may be configured to cause the electronic apparatus to: acquire spatial data from the second map data, the spatial data including at least one of environment information of a space, region information of the space, or object information within the space.

The electronic apparatus may further include an input interface comprising circuitry, wherein at least one processor, individually and/or collectively, is configured to cause the electronic apparatus to: acquire spatial data from the second map data, and perform an operation corresponding to an input and based on the input corresponding to the spatial data received through the input interface.

The electronic apparatus may further include a camera, wherein at least one processor, individually and/or collectively, is configured to cause the electronic apparatus to acquire spatial data based on the second map data and a captured image acquired using the camera.

According to an example embodiment of the present disclosure, provided is a method of controlling an electronic apparatus, the method including: acquiring first map data based on distance information from a wall surface acquired using a distance sensor; moving to a position corresponding to a scan pose for a reference point corresponding to scan data collection based on the first map data; and acquiring second map data based on scan data acquired using a depth sensor at the position corresponding to the scan pose.

The method may further include: acquiring data corresponding to a first map including distance information from a plurality of wall surfaces based on the first map data; and acquiring positions corresponding to a plurality of scan poses based on the distance information from the plurality of wall surfaces.

The acquiring of the plurality of scan poses may include: acquiring, as the positions corresponding to the plurality of scan poses, a plurality of positions each corresponding to a specified value based on a distance from each of the plurality of wall surfaces exceeding the specified value.

The method may further include: acquiring data corresponding to a first map including a plurality of grids based on the first map data; and acquiring respective centers of the plurality of grids as positions corresponding to scan poses.

The method may further include: acquiring a scan rotation angle based on a field of view (FoV) of the depth sensor; and acquiring the scan data using the depth sensor by rotating based on the scan rotation angle.

The method may further include: acquiring spatial data from the second map data; and acquiring data corresponding to a second map including the spatial data.

The method may further include acquiring spatial data from the second map data, the spatial data including at least one of environment information of a space, region information of the space, or object information within the space.

The method may further include: acquiring spatial data from the second map data; receiving an input corresponding to the spatial data; and performing an operation corresponding to the input based on the user input.

The method may further include acquiring spatial data based on the second map data and a captured image acquired using the camera.

According to an example embodiment of the present disclosure, provided is a non-transitory computer-readable recording medium including a program for executing a control method of an electronic apparatus, wherein the method includes: acquiring first map data based on distance information from a wall surface acquired using a distance sensor, moving to a position corresponding to a scan pose for a reference point corresponding to scan data collection based on the first map data, and acquiring second map data based on scan data acquired using a depth sensor at the position corresponding to the scan pose.

The method may further include acquiring data corresponding to a first map including distance information from a plurality of wall surfaces based on the first map data, and acquiring positions corresponding to a plurality of scan poses based on the distance information from the plurality of wall surfaces.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example operation of an electronic apparatus according to various embodiments;

FIG. 2 is a perspective view illustrating an example shape of the electronic apparatus according to various embodiments;

FIG. 3 is a block diagram illustrating an example configuration of the electronic apparatus according to various embodiments;

FIG. 4 is a block diagram illustrating an example configuration of the electronic apparatus according to various embodiments;

FIG. 5 is a diagram illustrating an example operation of the electronic apparatus for acquiring second map data according to various embodiments;

FIG. 6 is a diagram illustrating an example first map user interface (UI) according to various embodiments;

FIG. 7 is a diagram illustrating an example first map UI according to various embodiments;

FIG. 8 is a diagram illustrating an example operation of the electronic apparatus for acquiring the second map data according to various embodiments;

FIG. 9 is a diagram illustrating an example operation of the electronic apparatus for acquiring a changed scan pose according to various embodiments;

FIG. 10 is a flowchart illustrating an example operation of the electronic apparatus for scanning a space according to various embodiments;

FIG. 11 is a diagram illustrating an example operation of the electronic apparatus for acquiring a scan rotation angle according to various embodiments;

FIG. 12 is a diagram illustrating an example operation of the electronic apparatus for scanning a space using a distance sensor and a depth sensor according to various embodiments; and

FIG. 13 is a flowchart illustrating an example operation of the electronic apparatus for acquiring the second map data according to various embodiments.

### DETAILED DESCRIPTION

General terms that are currently widely used are selected as terms used in various embodiments of the present disclosure in consideration of their functions in the present disclosure, and may be changed based on the intention of those skilled in the art or a judicial precedent, the emergence of a new technique, or the like. In addition, in a specific case, terms may be arbitrarily chosen. In this case, the meanings of such terms are mentioned in detail in corresponding descriptions of the present disclosure. Therefore, the terms used in the present disclosure should be defined on the basis of the meanings of the terms and the contents throughout the present disclosure rather than simple names of the terms.

It should be understood that the various embodiments of the present disclosure and terms used herein are not intended to limit technical features described in the present disclosure to specific embodiments, and rather are intended to include various modifications, equivalents, and substitutions of the corresponding embodiments.

Throughout the accompanying drawings, similar components are denoted by similar reference numerals.

A singular noun corresponding to an item is intended to include one or more of the items unless a relevant context clearly indicates otherwise.

In the present disclosure, an expression such as “A or B”, “at least one of A and B”, “at least one of A or B”, “A, B, or C”, “at least one of A, B, and C”, “at least one of A, B, or C”, or the like may include any one of the items listed together or all possible combinations thereof.

Terms such as “first”, “second”, and the like may be used simply to distinguish one element and another element from each other, and do not limit the corresponding components in any other respect (e.g., importance or order).

If a component (e.g., a first component) is mentioned to be “coupled with/to” or “connected to” another component (e.g., a second component) with or without terms “operatively” or “communicatively”, it should be understood that the component may be directly coupled to another component (e.g., in a wired or wireless manner)-), in a wireless manner, or through a third component).

It should be further understood that terms “include”, “have” or the like, used in the disclosure specify the presence of features, numerals, steps, operations, components, parts mentioned in the disclosure or combinations thereof, and do not preclude the presence or addition of one or more other features, numerals, steps, operations, components, parts, or combinations thereof.

If a component is referred to as being “connected”, “coupled”, “supported”, or “in contact” with another component, it includes not only a case where the components are directly connected, coupled, supported, or in contact with each other, but also a case where the components are indirectly connected, coupled, supported, or in contact with each other through a third component.

If a component is referred to be disposed “on” another component, it includes not only a case where the component is in contact with another component, but also a case where still another component is interposed between the two components.

A term “and/or” includes a combination of a plurality of related component or any one of the plurality of related components.

In the present disclosure, a “module” or a “~er/~or” may perform at least one function or operation, and be implemented by hardware, software, or a combination of hardware and software. In addition, a plurality of “modules” or a plurality of “~ers/~ors” may be integrated in at least one module and be implemented by at least one processor 150 except for a “module” or a “~er/or” that is implemented by a specific hardware.

The various elements and areas in the drawings are schematically shown. Therefore, the spirit of the present disclosure is not limited by relative sizes or intervals shown in the accompanying drawings.

In the present disclosure, a term such as a “user” may refer to a person who uses an electronic apparatus or an apparatus (e.g., an artificial intelligence electronic apparatus) which uses an electronic apparatus.

Hereinafter, various example embodiments of the present disclosure is described in greater detail with reference to the accompanying drawings.

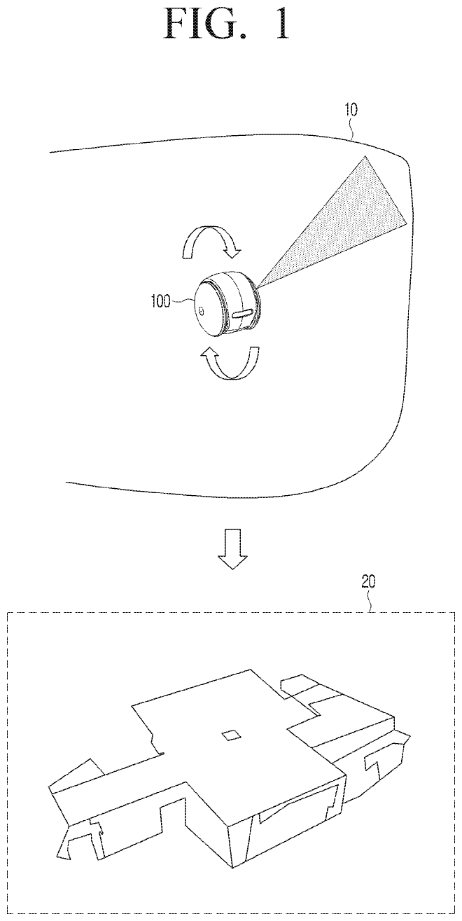

FIG. 1 is a diagram illustrating an example operation of an electronic apparatus according to various embodiments.

Referring to FIG. 1, an electronic apparatus 100 may acquire map data while traveling within a space. The “map data” may refer to data representing structural information of a specific space or environment.

For example, the electronic apparatus 100 may acquire first map data based on distance information from a wall surface acquired using a distance sensor, and may acquire second map data based on scan data acquired using a depth sensor.

A map may include a drawing expressing a state of the space in a reduced scale on a plane.

According to various embodiments of the present disclosure, a map may include a drawing in which a floor structure within a house is reduced in a predetermined scale and expressed by a predetermined symbol.

For example, a map may include a drawing expressing a floor structure within a house by lines. However, the present disclosure is not limited thereto, and a map may also include a position of a major object within the house.

The electronic apparatus 100 may acquire a position corresponding to a scan pose for a reference point corresponding to scan data collection based on the first map data, and may travel to the position corresponding to the scan pose to acquire the scan data.

Here, “traveling” may include an operation in which an object moves by power.

According to various embodiments of the present disclosure, “traveling” may include an operation in which an object moves by power in any direction. “raveling” may include an operation in which an object moves along a predetermined track by power.

For example, “traveling” may include an operation in which the electronic apparatus changes its position while acquiring a captured image of the space.

The “scan pose” refers to a reference point for collecting the scan data for the space, and may refer to an optimal position and posture that the electronic apparatus is required to take to scan a specific region or object.

The electronic apparatus 100 may travel to the position corresponding to the scan pose, then acquire the scan data using the depth sensor while rotating in place at the position corresponding to the scan pose, and acquire the second map data based on the acquired the scan data.

If the electronic apparatus 100 acquires data corresponding to a first map including distance information from a plurality of wall surfaces based on the first map data, the electronic apparatus 100 may acquire positions corresponding to a plurality of scan poses based on the distance information from the plurality of wall surfaces.

For example, the data corresponding to the first map may correspond to a first map user interface (UI) 10. The first map UI 10 (or a second map UI 20) or the like is described in greater detail below.

For example, the electronic apparatus 100 may calculate distances from the plurality of wall surfaces that surround the electronic apparatus 100 and are displayed on the first map UI 10, and may acquire a position corresponding to an optimal scan pose for scanning the space.

If the electronic apparatus 100 acquires the second map data based on the scan data acquired using the depth sensor at the position corresponding to the scan pose, the electronic apparatus 100 may acquire spatial data from the second map data.

The “spatial data” may refer to data related to geographic information, e.g., data for expressing a position and an attribute in a physical or virtual space. For example, the spatial data may include at least one of environment information of the space, region information of the space, or object information within the space.

The electronic apparatus 100 may acquire data corresponding to a second map including the spatial data based on the scan data. For example, the data corresponding to the second map may correspond to a second map UI 20.

The “first map UI” may refer to a map UI visually expressing a two-dimensional space, and the “second map UI” may refer to a map UI visually expressing a three-dimensional space.

FIG. 1 illustrates the electronic apparatus 100 as a movable projector. However, the present disclosure is not limited thereto, and the electronic apparatus 100 may be implemented as any of various types of electronic apparatuses such as a movable electronic apparatus or an electronic apparatus carried by a user.

A projector refers to a device that projects light including an image onto an external screen, a wall surface, or the like to display the image, and the movable projector refers to a projector movable using a wheel or a motor.

Hereinafter, operations of the electronic apparatus 100 according to various embodiments of the present disclosure are described in greater detail.

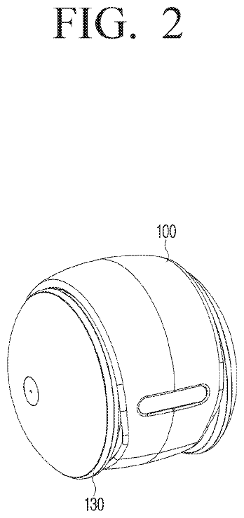

FIG. 2 is a perspective view illustrating an example shape of the electronic apparatus according to various embodiments.

FIG. 2 illustrates the electronic apparatus 100 in a movable form. This form is merely one example of a disclosed form, and the electronic apparatus 100 may have a shape different from the illustrated form.

The electronic apparatus 100 may acquire data (e.g., the distance information or an image) acquired by scanning the space using various sensors.

An image according to one example may include a captured image acquired using a sensor (e.g., a camera) provided in the electronic apparatus, an input image received from an external device through a communication unit (e.g., including communication circuitry), or a graphic image generated by the electronic apparatus, or the like.

Based on an aspect ratio, an image according to an example may include a wide image having a width longer than a height (e.g., a landscape image or a horizontal image), a tall image having a height longer than a width (e.g., a portrait image or a vertical image), or the like. For example, the wide image may include an image having a 16:9 aspect ratio, and the tall image may include an image having a 9:16 ratio. A specific number is merely an example for convenience of description, and the present disclosure is not limited thereto.

An image according to an example may include various resolutions based on the number of pixels included in the image (the product of the number of pixels in a horizontal direction and the number of pixels in a vertical direction). For example, based on a resolution, an image may include a high-resolution image (such as full high-definition (FHD, 1920×1080 pixels) or 8K (7680×4320 pixels)), a low-resolution image (such as 640×480 pixels), or the like.

“Capturing” according to an example of the present disclosure may include an operation of the electronic apparatus for acquiring an image by controlling a camera (e.g., a camera including an image sensor and a lens) provided in the electronic apparatus to convert an optical image formed through a lens into an electrical signal.

The electronic apparatus 100 may travel within the space along the plurality of scan poses acquired using a travel device 130.

For example, the electronic apparatus 100 may travel within the space by scanning the space in the order of nearest positions among the plurality of positions corresponding to a plurality of scan poses, to acquire the data acquired by scanning the space at the plurality of positions corresponding to the plurality of scan poses.

The electronic apparatus 100 may include the travel device 130 (e.g., a motor or a wheel) for movement, and perform the movement using the travel device included therein. The illustrated example shows and describes the electronic apparatus 100 as being moved using a wheel. However, in implementation, the electronic apparatus 100 may also use another means in a caterpillar track form. If implemented as a drone, the electronic apparatus 100 may also include a propeller mounted thereon instead of wheels.

The illustrated example shows the electronic apparatus 100 as directly including the travel device 130. However, the travel device 130 may be a separate device. For example, the electronic apparatus 100 may be coupled to a movable device such as a robot cleaner, and may be mounted on the robot cleaner to control a movement of the robot cleaner for operation.

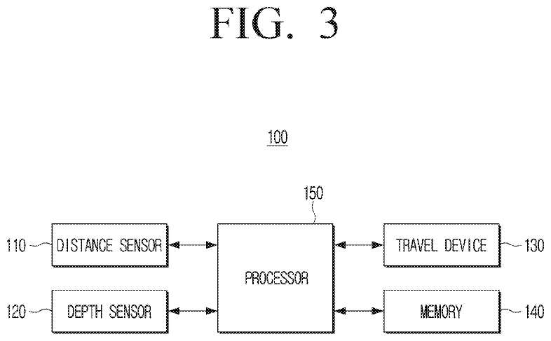

The illustrated form of the electronic apparatus is merely an example, and the electronic apparatus may be implemented in various forms. A more detailed configuration of the electronic apparatus 100 is described below with reference to FIG. 3.

FIG. 3 is a block diagram illustrating an example configuration of the electronic apparatus according to various embodiments.

Referring to FIG. 3, the electronic apparatus 100 may include a distance sensor 110, a depth sensor 120, the travel device (e.g., including a motor) 130, a memory 140, and a processor (e.g., including processing circuitry) 150.

According to an embodiment, the distance sensor 110 refers to a component for measuring a distance from various obstacles such as wall surfaces. For example, the electronic apparatus 100 may measure a distance between the electronic apparatus 100 and an obstacle around the electronic apparatus 100 based on a sensing value of the distance sensor 110.

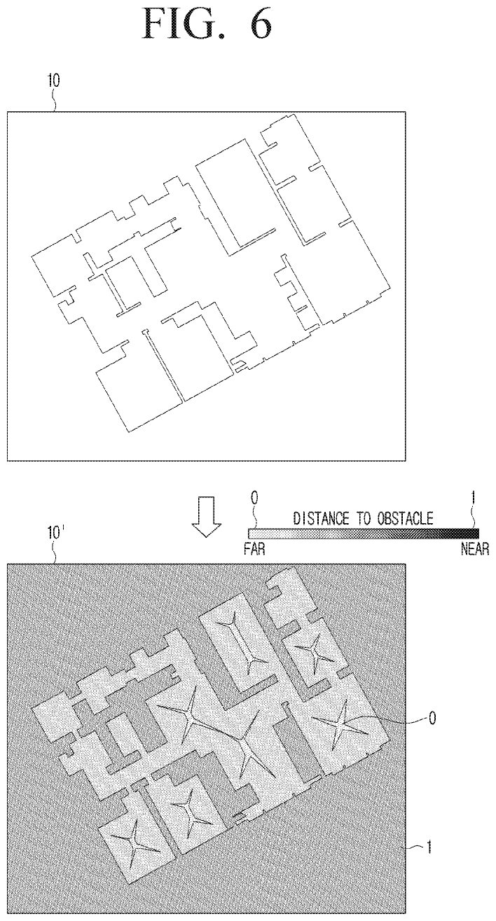

The electronic apparatus 100 may also acquire distance information between the plurality of wall surfaces based on the distance information between the electronic apparatus 100 and a wall surface. For example, if the electronic apparatus 100 acquires the distance information between the plurality of wall surfaces, the electronic apparatus 100 may generate data (e.g., a map UI) representing the distance information between the wall surfaces. This configuration is described in greater detail below with reference to FIG. 6.

The distance sensor 110 may include a 3D-time of flight (ToF) sensor, a ToF camera sensor, and a passive infrared (PIR) sensor. However, the present disclosure is not limited thereto, and the distance sensor 110 may include various sensors capable of measuring a distance from the obstacle.

If the distance sensor 110 acquires a sensing value for the obstacle, at least one processor 150 may acquire the distance information from the obstacle using the distance sensor 110.

The depth sensor 120 refers to a component for acquiring data including distance information from various obstacles such as wall surfaces. Here, the depth sensor 120 may include a 3D depth sensor.

For example, if the depth sensor 120 acquires a plurality of images including depth information, at least one processor 150 may acquire three-dimensional data of the space and the obstacle using the depth sensor 120.

In this case, the electronic apparatus 100 may rotate in place by 360 degrees and acquire the three-dimensional data of the space and the obstacle.

According to an embodiment, the travel device 130 refers to a component for moving the electronic apparatus 100. To this end, the travel device 130 may include a motor, a wheel, or the like, and may move the electronic apparatus 100 through a movement of the wheel.

The travel device 130 may adjust a scanning direction of the electronic apparatus 100. For example, as illustrated in FIG. 2, the travel device 130 may adjust a body position of the electronic apparatus 100 to adjust a direction in which a camera is oriented, or may adjust a lens position within the camera to adjust the scanning direction.

The scanning direction refers to a direction in which the obstacle is scanned, and may also be referred to as a direction in which the electronic apparatus is oriented, a projection direction, or the like.

According to an embodiment, the memory 140 may store various programs, data, instructions, or the like used in the electronic apparatus 100. In addition, the memory 140 may store various information according to the various embodiments of the present disclosure.

The memory 140 may be implemented as a memory embedded in the electronic apparatus 100 based on a data storage purpose, or may be implemented as a memory detachable from the electronic apparatus 100.

For example, data for driving the electronic apparatus 100 may be stored in the memory embedded in the electronic apparatus 100, and data for extended functions of the electronic apparatus 100 may be stored in the memory detachable from the electronic apparatus 100.

The memory embedded in the electronic apparatus 100 may be implemented as a volatile memory (e.g., a dynamic RAM (DRAM), a static RAM (SRAM), or a synchronous dynamic RAM (SDRAM)), a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (SSD)), or the like.

The memory detachable from the electronic apparatus 100 may be implemented as a memory card (e.g., a compact flash (CF), a secure digital (SD), a micro secure digital (Micro-SD), a mini secure digital (Mini-SD), an extreme digital (xD), or a multi-media card (MMC)), an external memory connectable to a universal serial bus (USB) port (e.g., a USB memory), or the like.

The memory 140 may include various instructions necessary for an operation of the processor 150. The instructions may include an instruction for acquiring the distance information from a wall surface using the distance sensor, an instruction for acquiring the position corresponding to a scan pose for the reference point corresponding to the scan data collection based on the first map data, an instruction for traveling to the position corresponding to the scan pose, an instruction for acquiring the second map data based on the scan data acquired using the depth sensor at the position corresponding to the scan pose, or the like.

The memory 140 may store the distance information from a wall surface acquired using the distance sensor 110 or the scan data acquired using the depth sensor 120.

The “distance information from a wall surface” may refer to a distance value between the electronic apparatus 100 and a wall surface present in the space where the electronic apparatus 100 is located.

The “scan data” may refer to data acquired by scanning a wall surface or the obstacle identified while the electronic apparatus 100 rotates and travels at the position corresponding to the scan pose.

The memory 140 may store the first map data, the first map UI, the second map data, or the second map UI.

The “first map data” may refer to two-dimensional data acquired using the distance sensor. For example, the first map data may include data expressed on X and Y axes of spatial information of the obstacle or a wall surface such as its position, size, and shape.

The “second map data” may refer to three-dimensional data acquired using the depth sensor. For example, the second map data may include data expressed on X, Y, and Z axes of the spatial information of the obstacle or a wall surface such as its position, size, and shape.

According to an embodiment, at least one processor 150 may include various processing circuitry and control overall operations of the electronic apparatus 100. In detail, at least one processor 150 may be connected to each component of the electronic apparatus 100 and control the overall operations of the electronic apparatus 100.

At least one processor 150 may perform the operations of the electronic apparatus 100 according to the various embodiments by executing at least one instruction stored in the memory.

According to an embodiment, at least one processor 150 may be implemented as a digital signal processor (DSP), a microprocessor, a time controller (TCON), each of which processes a digital signal. However, the processor 150 is not limited thereto, and may include at least one of a central processing unit (CPU), a micro controller unit (MCU), a micro processing unit (MPU), a controller, an application processor (AP), or a communication processor (CP), or an advanced RISC (Reduced Instruction Set Computer) machine (ARM) processor, or may be defined by a relevant term. In addition, the processor 150 may be implemented as a system-on-chip (SoC) or a large scale integration (LSI), having a built-in processing algorithm, or may be implemented as a field programmable gate array (FPGA). At least one processor 150 may perform various functions by executing computer executable instructions stored in the memory.

For example, at least one processor 150 may include at least one of a central processing unit (CPU), a graphics processing unit (GPU), an accelerated processing unit (APU), a many integrated core (MIC), a digital signal processor (DSP), a neural processing unit (NPU), a hardware accelerator, and/or a machine learning accelerator. Thus, the processor 150 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

At least one processor 150 may acquire the first map data based on the distance information from a wall surface acquired using the distance sensor 110.

For example, at least one processor 150 may acquire the distance information from a wall surface or the obstacle by receiving the value sensed by the distance sensor 110 for the wall surface or the obstacle, and may acquire the first map data including the distance information from a wall surface or the obstacle.

At least one processor 150 may control the travel device 130 to move to the position corresponding to the scan pose for the reference point corresponding to the scan data collection based on the first map data.

The “scan pose” refers to a reference point corresponding to the scan data collection for the space, and may refer to an optimal posture that the electronic apparatus is required to take to scan a specific region or object at the reference point.

The position corresponding to the scan pose may refer to a position of the reference point corresponding to the scan data collection. The reference point may refer to an optimal point for collecting the scan data.

For example, to acquire the map data of a specific region (e.g., a living room) among a plurality of regions, at least one processor 150 may scan a projection surface detected in the specific region and acquire a central point based on a plurality of projection surfaces as the reference point.

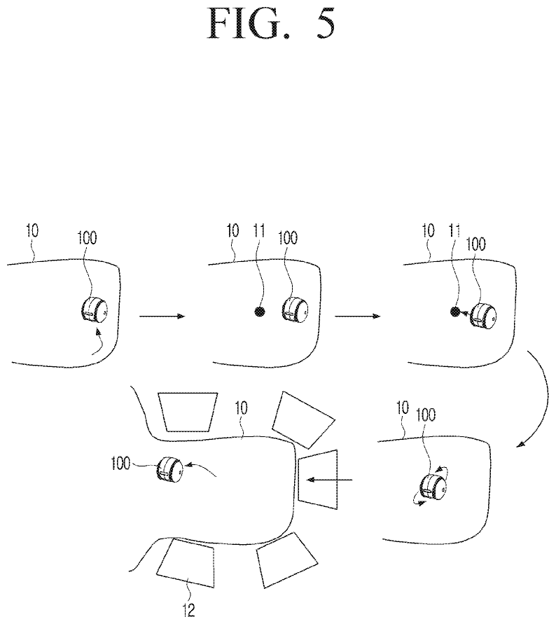

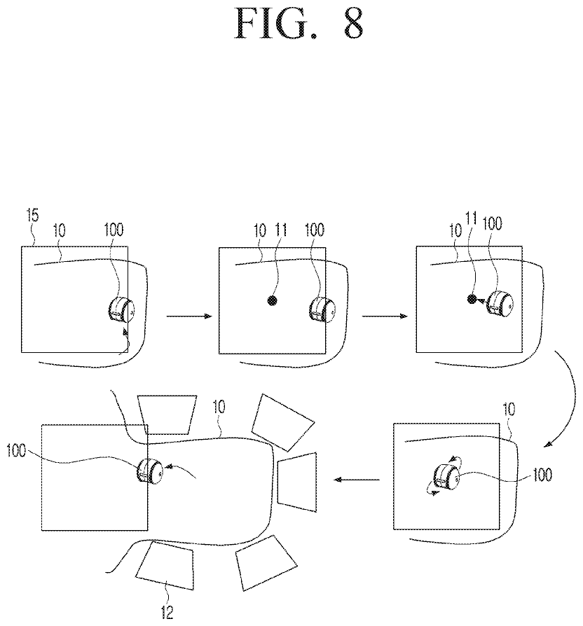

However, the present disclosure is not limited thereto, and at least one processor 150 may acquire the scan pose (e.g., the reference point corresponding to the scan data collection or the position of the reference point) based on a wall distance or a grid. This configuration is described in greater detail below with reference to FIGS. 5 and 8.

At least one processor 150 may acquire the second map data based on the scan data acquired using the depth sensor 120 at the position corresponding to the scan pose.

For example, at least one processor 150 may control the travel device 130 to rotate in place at the position corresponding to the scan pose, thereby acquiring the scan data for a plurality of projection surfaces using the depth sensor 120.

At least one processor 150 may acquire the data corresponding to the first map including distance information from the plurality of wall surfaces based on first map data. At least one processor 150 may also acquire the positions corresponding to the plurality of scan poses based on the distance information from the plurality of wall surfaces.

At least one processor 150 may travel along a plurality of scan poses as a travel path and may acquire the scan data for a plurality of projection surfaces using the depth sensor 120. This configuration is described in greater detail below with reference to FIG. 6.

At least one processor 150 may control one or any combination of other components included in the electronic apparatus, and may perform operations related to communication or data processing. At least one processor 150 may execute at least one program or instruction stored in the memory. For example, at least one processor 150 may perform a method according to an embodiment of the present disclosure by executing at least one instruction stored in the memory.

If the method according to an embodiment of the present disclosure includes a plurality of operations, the plurality of operations may be performed by one processor or may be performed by a plurality of processors.

For example, if a first operation, a second operation, and a third operation are performed by the method according to an embodiment, the first operation, the second operation, and the third operation may all be performed by a first processor, or the first operation and the second operation may be performed by the first processor (e.g., a general-purpose processor) and the third operation may be performed by a second processor (e.g., an artificial intelligence-specific processor).

One or more processors may control input data to be processed based on a predefined operation rule or an artificial intelligence model, stored in the memory 140. If one or more processors are the artificial intelligence-specific processors, the artificial intelligence-specific processor may be designed to have a hardware structure specialized for processing a specific artificial intelligence model. The predefined operation rule or the artificial intelligence model may be acquired by training.

The term “acquired by training” refers to that the predefined operation rule or the artificial intelligence model set to perform desired characteristics (or objectives) is acquired by training a basic artificial intelligence model using a plurality of training data using a training algorithm. Such training may be performed by a device itself that performs artificial intelligence according to the present disclosure, or may be performed through a separate server and/or system. Examples of training algorithms may include supervised learning, unsupervised learning, semi-supervised learning, or reinforcement learning. However, the present disclosure is not limited thereto.

The artificial intelligence model may include a plurality of neural network layers. Each of the plurality of neural network layers may have a plurality of weight values, and perform a neural network operation based on an operation between a result of an operation of a previous layer and the plurality of weight values. The plurality of weight values included in the plurality of neural network layers may be optimized by training results of the artificial intelligence model. For example, the plurality of weight values may be updated to reduce or minimize a loss value or a cost value acquired by the artificial intelligence model during a training process.

An artificial neural network may include a deep neural network (DNN). For example, the artificial neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), a deep Q-network, or the like. However, the present disclosure is not limited thereto.

At least one processor 150 may be implemented as a single-core processor including one core, or may be implemented as at least one multi-core processor including multiple cores (e.g., homogeneous multi-core or heterogeneous multi-core).

If at least one processor 150 is implemented as the multi-core processor, each of the multiple cores included in the multi-core processor may include an internal memory of the processor such as a cache memory or an on-chip memory, and a common cache shared by the multiple cores may be included in the multi-core processor.

Each of the multiple cores (or some of the multiple cores) included in the multi-core processor may independently read and perform a program instruction for implementing the method according to an embodiment of the present disclosure, or all (or some) of the multiple cores may be linked to read and perform the program instruction for implementing the method according to an embodiment of the present disclosure.

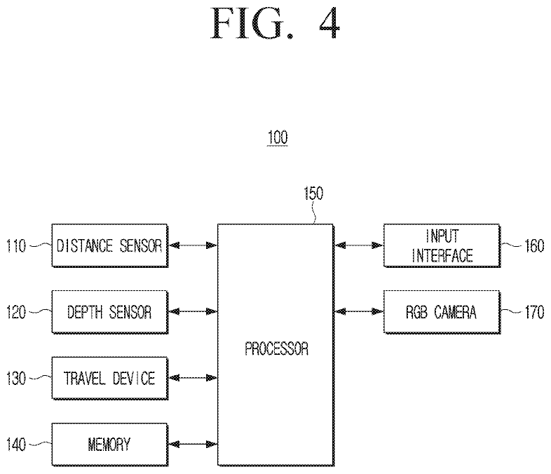

FIG. 4 is a block diagram illustrating an example configuration of the electronic apparatus according to various embodiments.

Referring to FIG. 4, the electronic apparatus 100 according to an embodiment of the present disclosure may include the distance sensor 110, the depth sensor 120, the travel device (e.g., including a motor) 130, the memory 140, at least one processor (e.g., including processing circuitry) 150, an input interface (e.g., including circuitry) 160, and/or a camera 170. Hereinafter, a redundant description of the above description may not be repeated here or may be summarized.

The input interface 160 may include various circuitry and receive various feedback from the user. For example, the electronic apparatus 100 may receive an input, e.g., a user input, corresponding to the spatial data through the input interface 160. The user input may correspond to an input including the spatial data. That is, the user input may include contents instructing performance of a specific command in a specific space.

The electronic apparatus 100 may perform an operation corresponding to the user input based on the received user input.

For example, if the electronic apparatus 100 receives a user input for settings controlling each component of the electronic apparatus 100 through the input interface, the electronic apparatus 100 may operate each component in response to the user input.

For example, if the input interface 160 receives a user input including the spatial data, at least one processor 150 may perform an operation corresponding to the user input.

For example, if the user utters “Come to the bedroom”, at least one processor 150 may receive the user input through a microphone and may control the travel device 130 to move to the bedroom.

The input interface 160 may include the microphone, a touchscreen, or the like. However, the present disclosure is not limited thereto, and the input interface 160 may include various input interfaces capable of receiving the user input.

The microphone is a component for receiving sound and converting the sound into an audio signal. The microphone may be electrically connected to at least one processor 150, and may receive sound under control of at least one processor 150.

For example, the microphone may be an integral type integrally formed on the upper side, front side, side portion, or the like of the electronic apparatus 100. Alternatively, the microphone may be provided in a remote controller or the like separate from the electronic apparatus 100. In this case, the remote controller may receive sound through the microphone, and may provide the received sound to the electronic apparatus 100.

The microphone may include various circuitry included in components such as a microphone for collecting analog sound, an amplifier circuit for amplifying the collected sound, an analog to digital (A/D) conversion circuit for sampling the amplified sound and converting the sound into a digital signal, a filter circuit for removing a noise component from the converted digital signal, and the like.

The microphone may be implemented as a sound sensor, and any component capable of collecting sound may be used.

According to an embodiment, the camera 170 (e.g., RGB camera) is a component for capturing an object and acquiring a color image. “Color” may refer to a combination of red, green, and blue. An “image” may include a still image or a moving image.

The camera 170 may be provided in at least one of the upper region, lower region, or side region of the electronic apparatus 100 to capture the space or the obstacle. The camera 170 may be implemented as one camera, or as a plurality of cameras according to an embodiment.

The camera 170 may provide a captured image to at least one processor 150 to acquire the map data in the image.

The camera 170 may be implemented as a wide-angle camera to capture a wide field of view. However, the present disclosure is not limited thereto. “Capturing” according to an example of the present disclosure may include an operation of the electronic apparatus for acquiring an image by controlling a camera (e.g., a camera including an image sensor and a lens) provided in the electronic apparatus to convert an optical image formed through a lens into an electrical signal.

The camera 170 may include a lens, a shutter, an aperture, a solid-state image sensor, an analog front end (AFE), and a timing generator (TG). The shutter may adjust a time during which light reflected from an object enters the camera, and the aperture may mechanically increase or decrease a size of an opening through which light enters to adjust an amount of light incident on the lens. The solid-state image sensor may output an electrical signal of an image if light reflected from an object is accumulated as photocharges. The TG may output a timing signal for reading out pixel data of the solid-state image sensor, and the AFE may sample the electrical signal output from the solid-state image sensor and digitizes the signal.

If the camera 170 acquires the captured image, at least one processor 150 may acquire the spatial data based on the captured image and the second map data.

For example, at least one processor 150 may acquire more diverse spatial data (e.g., a 3D map including color information) by coupling the second map data and the captured image acquired using the camera 170.

FIG. 4 illustrates the electronic apparatus 100 including various additional components. However, in implementation, the electronic apparatus 100 may omit some of the illustrated components. In addition, the electronic apparatus 100 may also include other components not illustrated.

For example, the electronic apparatus 100 may further include the communication unit.

For example, the communication unit may include various communication circuitry and perform data communication between an external device and the electronic apparatus using at least one of data communication methods including wired local area network (LAN), wireless LAN, wireless-fidelity (Wi-Fi), Wi-Fi Direct, Bluetooth, ZigBee, Wi-Fi Direct (WFD), infrared data association (IrDA), Bluetooth Low Energy (BLE), near field communication (NFC), wireless broadband internet (Wibro), worldwide interoperability for microwave access (WiMAX), shared wireless access protocol (SWAP), wireless gigabit alliances (WiGig), and radio frequency (RF) communication.

The communication unit may perform communication according to various wireless communication standards such as ZigBee, third generation (3G), third generation partnership project (3GPP), long term evolution (LTE), LTE advanced (LTE-A), fourth generation (4G), and fifth generation (5G), in addition to the communication methods described above.

At least one processor 150 may receive a signal for requesting data for acquiring the second map data from the server or the like through the communication unit.

At least one processor 150 may transmit a signal for requesting the second map data or the like to the server or the like through the communication unit. For example, at least one processor 150 may perform an operation corresponding to the user input corresponding to a specific place among the second map data based on the received second map data.

At least one processor 150 may also receive, from a server device or the like, a control signal for moving the electronic apparatus to the position corresponding to the scan pose based on the first map data, or a control signal for acquiring a second projection region. However, the present disclosure is not limited thereto.

The electronic apparatus 100 may further include an interface such as a high definition multimedia interface (HDMI), a DisplayPort (DP), a red-green-blue (RGB), a digital visual interface (DVI), a universal serial bus (USB), or Thunderbolt for receiving video and audio signals by being connected to the external device or the servers. HDMI, DP, or Thunderbolt refers to a port capable of simultaneously transmitting the video and audio signals. The electronic apparatus 100 may perform various processing such as demuxing, decoding, and scaling for various signals received from the external device, the server communicating with the external device, or the like through the communication unit and such various interfaces, and may output the distance information and the second map data.

The electronic apparatus 100 may include a display.

The display is a component for displaying an operation state of the electronic apparatus 100, an alarm message, a UI screen, or the like. The display may be implemented as any of various types such as a liquid crystal display (LCD), an organic light-emitting diode (OLED) display, or a plasma display panel (PDP). The display may also include a driving circuit implemented as an amorphous silicon thin film transistor (a-si TFT), a low temperature poly silicon (LTPS) TFT, an organic TFT (OTFT), a backlight unit, and the like. The display may be implemented as a touchscreen coupled to a touch sensor, a flexible display, or a three-dimensional display (3D display). The display may be implemented using one or more light emitting elements.

The electronic apparatus 100 may change a display state of the display based on various states such as the electronic apparatus 100 being turned on, in a normal operation state, in a low power state, in an error state, or the like to enable the user to intuitively recognize a state of the electronic apparatus 100.

For example, at least one processor 150 may control the display to display a UI corresponding to the acquired second map data. The UI corresponding to the second map data may correspond to a graphic element visually representing the second map data as a 2D or 3D map.

However, the present disclosure is not limited thereto, and at least one processor 150 may control the display to display a UI corresponding to the first map data before acquiring the second map data.

However, a display configuration is only one example among the various embodiments, and the display configuration may be omitted. For example, the electronic apparatus 100 may be an apparatus directly including the display, or a device connected to the external device.

For example, if the electronic apparatus 100 is implemented as a set-top box, a one-connect box, a projector, or the like, the operations of the electronic apparatus 100 described above may also be performed by the electronic apparatus not including a display.

In this case, at least one processor 150 may acquire a UI or the like based on the second map data, and may provide the acquired UI to an external display device (a device including a display) through the communication unit. The external display device may display the provided UI on the display included in the external display device.

The electronic apparatus 100 may include a microphone. The microphone may correspond to a configuration included in the input interface 160 described above.

The microphone may receive a user voice in an activated state. For example, the microphone may be integrally formed on the upper side, front side, side portion, or the like of the electronic apparatus 100.

The microphone may include various components such as a microphone for collecting the user voice in an analog form, an amplifier circuit for amplifying the collected user voice, an analog to digital (A/D) conversion circuit for sampling the amplified user voice and converting the user voice into a digital signal, a filter circuit for removing a noise component from the converted digital signal, and the like.

The microphone may receive the user voice and may transmit the received user voice to the electronic apparatus 100. The electronic apparatus 100 may input the received user voice into a voice recognition model and may perform voice recognition. For example, the electronic apparatus 100 may perform STT (speech to text) on the user voice and may perform voice recognition on the user voice.

For example, at least one processor 150 may receive the user input as the user input through the microphone. The user input may correspond to a user input corresponding to the spatial data. The spatial data is specifically described below.

Hereinafter, an example operation of the electronic apparatus 100 is described in greater detail with reference to FIGS. 5 to 13. For convenience of description, various example embodiments are described with reference to FIGS. 5 to 13. However, the example embodiments in FIGS. 5 to 13 may be combined and implemented.

FIG. 5 is a diagram illustrating an example operation of the electronic apparatus for acquiring the second map data according to various embodiments.

Referring to FIG. 5, the electronic apparatus 100 may acquire 2D map data by mapping the space while traveling within the space and generate a 2D map UI 20.

:Mapping” may refer to an operation of converting or interconnecting a system, data, space, concept, or the like into another format or structure. For example, “mapping” may include geographic mapping visually representing a specific position, path, or the spatial data.

Referring to FIG. 5, the electronic apparatus 100 may acquire a position corresponding to a scan pose for a reference point 11 corresponding to the scan data collection, based on the first map data. For example, if the electronic apparatus 100 extracts the distance information from the plurality of wall surfaces based on the first map data, the electronic apparatus 100 may acquire the most central position from the plurality of wall surfaces as a position of the reference point 11.

Referring to FIG. 5, the electronic apparatus 100 may move to the position of the reference point 11 to acquire the scan data for the plurality of wall surfaces.

The electronic apparatus 100 may rotate in place at the position of the reference point 11 (a reference point corresponding to the scan pose) to collect the scan data for a plurality of projection surfaces 12.

If the electronic apparatus 100 completes the collection of the scan data for the plurality of wall surfaces at the reference point 11, the electronic apparatus 100 may move to the nearest position and then repeatedly perform an operation of collecting the scan data for the plurality of wall surfaces while rotating in place until completion of the data collection at all positions (positions corresponding to the scan poses).

FIG. 6 is a diagram illustrating an example first map user interface (UI) according to at least various embodiments.

The electronic apparatus 100 may acquire the first map data based on the distance information from a wall surface acquired using the distance sensor, and may acquire the data corresponding to the first map including distance information from the plurality of wall surfaces based on the first map data. The data corresponding to the first map may correspond to the first map UI.

For example, the electronic apparatus 100 may generate the first map UI 10 representing the distance information from the plurality of wall surfaces as relative distances on the map based on the first map data. For example, if distance values from the plurality of wall surfaces acquired using the distance sensor indicate that the distance value in a region B is larger than the distance value in a region A, the electronic apparatus 100 may generate a map UI to make the region B occupy a larger region than the region A.

In addition, the electronic apparatus 100 may also generate a distance map UI 10′ representing degrees of distances from the plurality of wall surfaces at respective positions on the map based on the first map data.

For example, the electronic apparatus 100 may represent degrees of the distances from the plurality of wall surfaces by displaying white (0) at respective positions on the map for larger distances from the obstacle and black (1) for smaller distances.

However, the present disclosure is not limited thereto, and a degree of proximity to the obstacle may be displayed on the map UI through various visual expression methods.

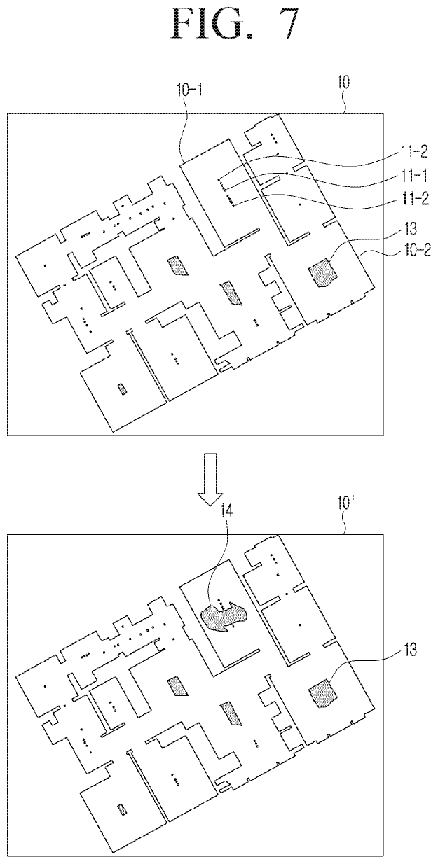

FIG. 7 is a diagram illustrating an example first map UI according to various embodiments.

Referring to FIG. 7, the electronic apparatus 100 may acquire, as the positions corresponding to the scan poses, a plurality of positions having the largest or equal distance values from the plurality of wall surfaces in each region on the first map UI 10.

For example, with respect to the plurality of wall surfaces forming a specific region 10-1, the electronic apparatus 100 may acquire, as a scan pose 11-1, a position in which distance values from the nearest two wall surfaces are equal and distance values from the farthest two wall surfaces are the largest.

With respect to the plurality of wall surfaces forming the specific region 10-1, the electronic apparatus 100 may acquire, as a scan pose 11-2, a position in which distance values from the plurality of nearest wall surfaces are equal to one another.

However, the present disclosure is not limited thereto, and the electronic apparatus 100 may also acquire, as the position corresponding to the scan pose, a position on a straight line connecting the scan pose 11-1 and the scan pose 11-2 forming the specific region 10-1.

In this case, the electronic apparatus 100 may acquire the scan data by traveling along the linearly connected scan poses and scanning the projection surface.

If the electronic apparatus 100 completes the scanning at a position corresponding to a specific scan pose using the depth sensor, the electronic apparatus 100 may update the map by indicating a scanning completion mark on the existing first map UI to prevent and/or reduce a region already scanned from being scanned again.

For example, if the electronic apparatus 100 completes the scanning of the projection surface at the scan pose 11-1, the electronic apparatus 100 may update the existing first map UI 10 to a new first map UI 10 by marking the scanned region as a gray region 14.

However, the present disclosure is not limited thereto, and an indication of the scanned region may be displayed on the map UI through various visual expression methods.

The electronic apparatus 100 may acquire, as the positions corresponding to the plurality of scan poses, a position corresponding to a predetermined value if the distance from each of the plurality of wall surfaces exceeds the predetermined value.

For example, the electronic apparatus 100 may acquire the first map UI displaying a region 13 exceeding the predetermined value with respect to each of the plurality of wall surfaces forming a specific region 10-2, and may acquire boundary regions of the region 13 exceeding the predetermined value as the positions corresponding to the plurality of scan poses.

In this case, the electronic apparatus 100 may acquire the scan data by traveling along the boundary regions of the region 13 each exceeding the predetermined value and scanning the projection surfaces.

FIG. 8 is a diagram illustrating an example operation of the electronic apparatus for acquiring the second map data according to various embodiments.

Referring to FIG. 8, the electronic apparatus 100 may generate the data corresponding to the first map including a plurality of grids (e.g., the first map UI 10), and may acquire the position corresponding to the scan pose based on each grid.

For example, the electronic apparatus 100 may generate the first map UI including the plurality of grids based on the first map data, and may acquire respective centers of the plurality of grids as the positions corresponding to the scan poses.

For example, the electronic apparatus 100 may acquire a center of a grid 15 displayed on the first map UI 10 as the position corresponding to the scan pose (the position of the reference point 11). The electronic apparatus 100 may move to the reference point 11 acquired based on the grid 15, and may scan the plurality of projection surfaces 12 while rotating in place at the reference point 11.

If the electronic apparatus 100 completes the scanning of the projection surfaces at the grid 15 in which the electronic apparatus 100 is positioned, the electronic apparatus 100 may move to another adjacent grid and repeat the above operation until completion of the scanning operations at all the grids.

As described above, the electronic apparatus 100 may acquire the scan pose (or the position corresponding to the scan pose) based on the grid or the wall distance.

The electronic apparatus 100 may acquire the distance between the electronic apparatus 100 and the plurality of wall surfaces based on map data (the first map data) primarily acquired. The map data may correspond to data acquired from the space around the electronic apparatus 100. The surrounding space may include the plurality of wall surfaces and obstacles.

If the electronic apparatus 100 acquires the scan poses based on the distances from the plurality of wall surfaces, the electronic apparatus 100 may acquire the reference point (for scanning the surrounding space using the depth sensor) without moving close to the wall surface (or a specific space (e.g., a room)). Accordingly, the electronic apparatus 100 may sense another space without directly moving to the acquired reference point to additionally acquire a plurality of reference points. In this way, the electronic apparatus 100 may compare the plurality of reference points to acquire a more optimal position.

If the scan pose is acquired based on the wall distance, the electronic apparatus 100 may acquire the map data based only on the distances from the plurality of wall surfaces. Accordingly, if the plurality of obstacles are located in the surrounding space, the electronic apparatus 100 may not acquire the map data based on information on the positions and sizes of the obstacles. The obstacle may correspond to an obstacle at a lower height (lower than a wall height) that the electronic apparatus 100 may encounter.

In this case, the electronic apparatus 100 is incapable of generating the map data considering both the wall surfaces and the obstacles. Accordingly, the electronic apparatus 100 may not accurately identify the optimal position (the reference point) for acquiring the scan data for the surrounding space.

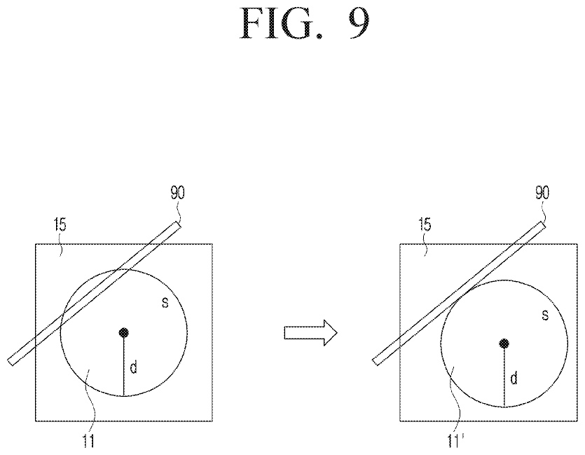

The electronic apparatus 100 may acquire respective centers of the plurality of grids acquired as the positions corresponding to the scan poses. In this case, unlike the case where the scan pose are acquired based on the wall distance, the electronic apparatus 100 may consider the obstacles around the electronic apparatus 100. This configuration is described in greater detail below with reference to FIG. 9.

FIG. 9 is a diagram illustrating an example operation of the electronic apparatus for acquiring a changed scan pose according to various embodiments.

If an obstacle 90 interfering with the traveling of the electronic apparatus 100 is present in the grid 15, the electronic apparatus 100 may acquire, as a new reference point 11′, a point in which the obstacle is not located within a predetermined region(s) from the existing reference point 11 which is the center of the grid.

The predetermined region(s) may refer to a region(s) s including all regions within a predetermined distance d from the electronic apparatus 100.

If the electronic apparatus 100 goes out of a grid region within the predetermined distance d from the new reference point 11′, the electronic apparatus 100 may exclude a corresponding grid from grid candidates. The grid candidates may correspond to grids corresponding to respective candidate reference points among a plurality of candidate reference points that may be final reference points.

Accordingly, if the plurality of low-height obstacles are present around the electronic apparatus 100, the electronic apparatus 100 may exclude the corresponding grid from the candidates, thereby preventing/reducing unnecessary generation of the plurality of grid candidates for selection of a projection scanning position. In this way, the electronic apparatus 100 may more efficiently shorten an entire process for acquiring the reference point if the electronic apparatus 100 acquires the reference point based on the grid instead of the wall distance.

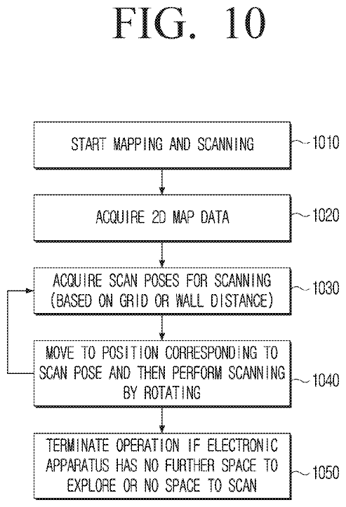

FIG. 10 is a flowchart illustrating an example operation of the electronic apparatus for scanning the space according to various embodiments.

The electronic apparatus 100 may start the scanning while traveling within the space and mapping the space to acquire the map data (1010).

The electronic apparatus 100 may acquire the 2D map data by scanning and mapping the space using the distance sensor while traveling within the space (1020).

The electronic apparatus 100 may acquire the scan poses for scanning the plurality of projection surfaces based on the 2D map data (1030). The scan poses may include scan poses acquired based on the grids and the scan poses acquired based on the wall distance.

Acquiring the scan pose may also refer to acquiring a position of the electronic apparatus 100 corresponding to the scan pose. Here, the position may correspond to the position of the reference point corresponding to acquiring the scan pose. This configuration is described in detail above, and a detailed description thereof may not be repeated here.

If the electronic apparatus 100 acquires the position corresponding to the scan pose, the electronic apparatus 100 may move to the nearest position (the position corresponding to the scan pose) and then scan the plurality of projection surfaces by rotating at the corresponding position (1040). The electronic apparatus 100 may acquire the scan data by scanning the plurality of projection surfaces using the depth sensor.

The electronic apparatus 100 may acquire the 3D map data based on the 2D map data and the scan data acquired using the depth sensor.

The electronic apparatus 100 may terminate the operation for acquiring the map data if the electronic apparatus 100 has no further space to explore or no space to scan while traveling within the space (1050).

The “space to explore” may refer to a region not yet searched by the electronic apparatus 100 or a space in which data is not yet collected.

However, the present disclosure is not limited thereto, and if the electronic apparatus 100 detects a change in an environment such as a change in furniture or a change in the space, the electronic apparatus 100 may repeat the above operation again to acquire the map data and update the map.

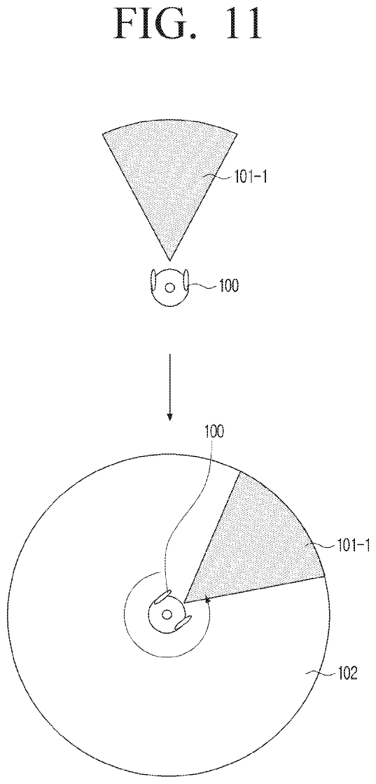

FIG. 11 is a diagram illustrating an example operation of the electronic apparatus for acquiring a scan rotation angle according to various embodiments.

The electronic apparatus 100 may change the rotation angle for scanning in consideration of a field of view (FoV) of the depth sensor.

For example, the electronic apparatus 100 may acquire the scan rotation angle based on the field of view of the depth sensor, and may control the travel device to rotate based on the scan rotation angle. The electronic apparatus 100 may acquire the scan data using the depth sensor while rotating based on the scan rotation angle.

For example, if a field of view 101-1 of the depth sensor is 60 degrees, the electronic apparatus 100 may change a scan rotation angle 102 from 360 degrees to an angle greater than or equal to 300 degrees.

On the other hand, if the FoV of the depth sensor is 180 degrees, the electronic apparatus 100 may change the scan rotation angle from 360 degrees to an angle greater than or equal to 180 degrees.

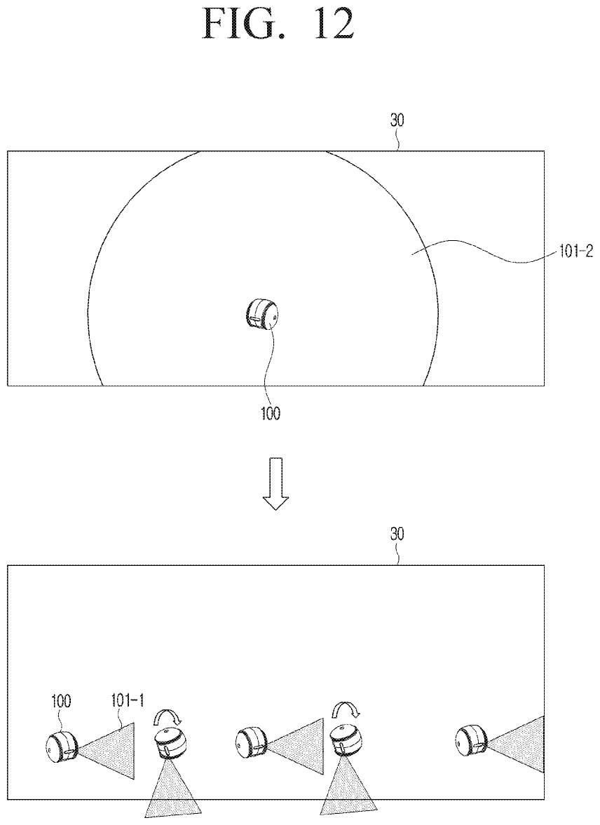

FIG. 12 is a diagram illustrating an example operation of the electronic apparatus for scanning the space using the distance sensor and the depth sensor according to various embodiments.

The electronic apparatus 100 may acquire the distance information from the wall surface or the 2D data by scanning a space 30 using the distance sensor. In addition, the electronic apparatus 100 may acquire the scan data or the 3D data by scanning the space 30 using the depth sensor.

Meanwhile, the distance sensor may scan the space based on a wider field of view than the depth sensor.

For example, the electronic apparatus 100 may acquire a sensing value for the space in a range of about 360 degrees based on a field of view 101-2 of the distance sensor.

On the other hand, the electronic apparatus 100 may acquire a sensing value for the space in a range of about 30 degrees to 90 degrees based on the field of view 101-1 of the depth sensor.

However, the present disclosure is not limited thereto, and the space may be scanned based on various fields of view of the sensors.

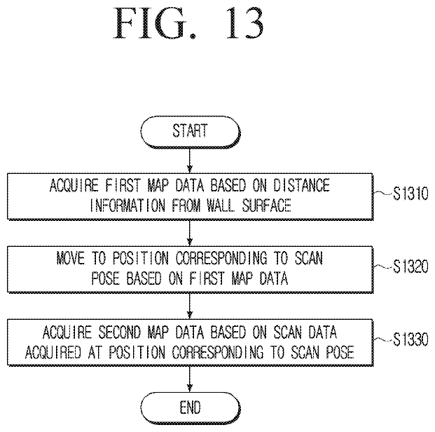

FIG. 13 is a flowchart illustrating an example operation of the electronic apparatus for acquiring the second map data according to various embodiments.

The electronic apparatus may acquire the first map data based on the distance information from the wall surface (S1310). For example, the electronic apparatus may acquire the 2D data based on the distance information from the wall surface acquired using the distance sensor.

The electronic apparatus may move to the acquired position (the position corresponding to the scan pose) based on the first map data (S1320). For example, the electronic apparatus may acquire the position corresponding to the scan pose for the reference point corresponding to the scan data collection based on the 2D map data. The electronic apparatus may move to the nearest position among the plurality of scan poses to acquire the scan data.

The electronic apparatus may acquire the second map data based on the scan data acquired at the position corresponding to the scan pose (S1330). For example, the electronic apparatus may acquire the 3D map data based on the scan data acquired using the depth sensor at the position corresponding to the scan pose.

The electronic apparatus may generate the 3D map UI including the various spatial data based on the 2D map data and the 3D map data.

The method for acquiring the map data described with reference to FIG. 13 may be performed by an apparatus having various configurations as described with reference to FIGS. 3 and 4. However, the present disclosure is not necessarily limited thereto, and the method may also be performed by an apparatus having various other configurations.

The various embodiments described above may be implemented individually, and one or more embodiments may be entirely or partially combined and implemented in one apparatus.

According to the various embodiments described above, the electronic apparatus may acquire the first map data using the distance sensor, move to the position corresponding to the scan pose acquired based on the first map data, and acquire the second map data using the depth sensor, thereby accurately and quickly generating the 3D map. Ultimately, user experience may be improved.

The various embodiments of the present disclosure may also be implemented as software stored in a storage medium (e.g., a non-transitory machine-readable storage medium) that may be mounted on or connected to a smartphone, a user terminal device, or any of other various electronic apparatuses (e.g., a computer).

For example, a non-transitory computer-readable storage medium may be provided in which software is stored for sequentially performing acquiring the first map data based on the distance information from the wall surface acquired using the distance sensor, moving to the position corresponding to the scan pose for the reference point corresponding to the scan data collection based on the first map data, and acquiring the second map data based on the scan data acquired using the depth sensor at the position corresponding to the scan pose.

An apparatus equipped with such a non-transitory computer-readable storage medium may perform the various operations such as acquiring the first map data based on the distance information from the wall surface, moving to the position corresponding to the scan pose for the reference point corresponding to the scan data collection, acquiring the second map data based on the scan data acquired using the depth sensor, and the like, as described in the various embodiments above.

In a non-transitory computer-readable storage medium, the “non-transitory” storage medium is tangible without including a signal, and does not distinguish whether data are semi-permanently or temporarily stored on the storage medium.

A program for performing the method according to the various embodiments described above may be distributed online via an application store. In case of the online distribution, at least portions of the computer program product may be at least temporarily stored on a storage medium such as the memory of a server of a manufacturer, a server of an application store or a relay server, or be temporarily generated.

Each of the components (for example, modules or programs) according to the various embodiments may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner.

Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the various example embodiments according to the present disclosure are illustrated and described as above, the present disclosure is not limited to the above-described specific embodiments, and may be variously modified by those skilled in the art to which the present disclosure pertains without departing from the gist of the present disclosure including accompanying claims and their equivalents. These modifications should also be understood to fall within the scope and spirit of the present disclosure. It will also be understood that any of the embodiment(s) described herein may be used in conjunction with any other embodiment(s) described herein.

What is claimed is:

1. An electronic apparatus comprising:
a distance sensor configured to measure a distance from a wall surface;
a depth sensor;
a travel device comprising a motor;
a memory storing at least one instruction; and
at least one processor, comprising processing circuitry, individually and/or collectively, configured to execute the at least one instruction, and to cause the electronic apparatus to:
acquire first map data based on distance information from the wall surface acquired using the distance sensor,
control the travel device to move to a position corresponding to a scan pose for a reference point corresponding to scan data collection based on the first map data, and
acquire second map data based on scan data acquired using the depth sensor at the position corresponding to the scan pose.

2. The apparatus as claimed in claim 1, wherein at least one processor, individually and/or collectively, is configured to cause the electronic apparatus to:
acquire data corresponding to a first map including distance information from a plurality of wall surfaces based on the first map data, and
acquire positions corresponding to a plurality of scan poses based on the distance information from the plurality of wall surfaces.

3. The apparatus as claimed in claim 2, wherein at least one processor, individually and/or collectively, is configured to cause the electronic apparatus to: acquire, as the positions corresponding to the plurality of scan poses, a plurality of positions each corresponding to a specified value based on a distance from each of the plurality of wall surfaces exceeding the specified value.

4. The apparatus as claimed in claim 1, wherein at least one processor is, individually and/or collectively, is configured to cause the electronic apparatus to:
acquire data corresponding to a first map including a plurality of grids based on the first map data, and
acquire respective centers of the plurality of grids as positions corresponding to scan poses.

5. The apparatus as claimed in claim 1, wherein at least one processor, individually and/or collectively, is configured to cause the electronic apparatus to:
acquire a scan rotation angle based on a field of view (FoV) of the depth sensor, and
control the travel device to rotate based on the scan rotation angle to acquire the scan data using the depth sensor.

6. The apparatus as claimed in claim 1, wherein at least one processor, individually and/or collectively, is configured to cause the electronic apparatus to:
acquire spatial data from the second map data, and
acquire data corresponding to a second map including the spatial data.

7. The apparatus as claimed in claim 1, wherein at least one processor, individually and/or collectively, is configured to cause the electronic apparatus to acquire spatial data from the second map data,
wherein the spatial data includes at least one of environment information of a space, region information of the space, or object information within the space.

8. The apparatus as claimed in claim 1, further comprising an input interface, comprising circuitry;
wherein at least one processor, individually and/or collectively, is configured to cause the electronic apparatus to:
acquire spatial data from the second map data, and
perform an operation corresponding to an input based on the input corresponding to the spatial data received through the input interface.

9. The apparatus as claimed in claim 1, further comprising a camera,
wherein at least one processor, individually and/or collectively, is configured to cause the electronic apparatus to acquire spatial data based on the second map data and a captured image acquired using the camera.

10. A method of controlling an electronic apparatus, the method comprising:
acquiring first map data based on distance information from a wall surface acquired using a distance sensor;
moving to a position corresponding to a scan pose for a reference point corresponding to scan data collection based on the first map data; and
acquiring second map data based on scan data acquired using a depth sensor at the position corresponding to the scan pose.

11. The method as claimed in claim 10, further comprising:
acquiring data corresponding to a first map including distance information from a plurality of wall surfaces based on the first map data; and
acquiring positions corresponding to a plurality of scan poses based on the distance information from the plurality of wall surfaces.

12. The method as claimed in claim 11, wherein the acquiring of the plurality of scan poses includes acquiring, as the positions corresponding to the plurality of scan poses, a plurality of positions each corresponding to a specified value based on a distance from each of the plurality of wall surfaces exceeding the specified value.

13. The method as claimed in claim 10, further comprising:
acquiring data corresponding to a first map including a plurality of grids based on the first map data; and
acquiring respective centers of the plurality of grids as positions corresponding to scan poses.

14. The method as claimed in claim 10, further comprising:
acquiring a scan rotation angle based on a field of view (FoV) of the depth sensor, and
acquiring the scan data using the depth sensor by rotating based on the scan rotation angle.

15. A non-transitory computer-readable recording medium having recorded thereon a program which, when executed by at least one processor, comprising processing circuitry, of an electronic apparatus, individually and/or collectively, cause the electronic apparatus to perform a method, wherein the method includes
acquiring first map data based on distance information from a wall surface acquired using a distance sensor,
moving to a position corresponding to a scan pose for a reference point corresponding to scan data collection based on the first map data, and
acquiring second map data based on scan data acquired using a depth sensor at the position corresponding to the scan pose.
